(19) United States
(12) Patent Application Publication
(10) Pub. No.: US 2006/0048802 A1
(43) Pub. Date: Mar. 9, 2006

(54) Electric cleaning device for a shaving apparatus

(76) Inventors: Diana Kappes, Eppstein (DE); Andreas Larscheid, Kelkheim (DE); Uwe Ludascher, Frankfurt am Main (DE)

Correspondence Address: FISH & RICHARDSON PC, P.O. BOX 1022, MINNEAPOLIS, MN, 55440-1022, US

(21) Appl. No.: 11/243,243

(22) Filed: Oct. 4, 2005

Related U.S. Application Data
(63) Continuation of application No. PCT/EP04/01389, filed on Feb. 13, 2004.

(30) Foreign Application Priority Data
Apr. 4, 2003 (DE) 103 15 452.3

(51) Int. Cl. B08B 3/12

(52) U.S. Cl. 134/184

(57) ABSTRACT

An electric shaving apparatus cleaning device for a shaving apparatus, with an upper portion having a cleaning receptacle for receiving the shaving head section of the shaving apparatus, and an electric motor powered fluid impeller for a cleaning fluid. In the shaving apparatus cleaning device, the upper portion is supported upon a replaceable cartridge holding a supply of cleaning fluid.

This application is a continuation of PCT application serial number PCT/EP2004/001389, filed Feb. 13, 2004, which claims priority under 35 U.S.C. § 119(a) from German application serial number DE 103 15 452.3, filed Apr. 4, 2003, the entire contents of both of which are hereby incorporated by reference.

### TECHNICAL FIELD

This invention relates to an electric shaving apparatus cleaning device.

### BACKGROUND

Electric cleaning devices for shaving apparatus serve the function of removing particles of hair and other debris that adhere to a shaving head section of the shaving apparatus.

FR 2 568 111 A1 discloses a device for cleaning a shaving head of a dry shaving apparatus, which includes a cleaning chamber into which the dry shaving apparatus is introduced for cleaning. Cleaning is effected by means of an air stream produced by a fan. Hair particles or other particles carried away with the air stream are conveyed to a filter device.

U.S. Pat. No. 3,172,416 discloses a cleaning device for an electric razor, which has a casing with an access opening for receiving the cutter portion of the razor. The casing accommodates a motor-driven fluid impelling assembly for generating a circulating current of a cleaning fluid, and a collector for accumulating hair and other particles. For cleaning, cleaning fluid is flushed through the cutter portion while, at the same time, the razor which is connected to the cleaning device is set in operation.

DE 44 02 238 C2 discloses a cleaning device for the shaving head of a dry shaver. The cleaning device includes a receptacle for the shaving head of the shaving apparatus and at least one cleaning fluid reservoir. The receptacle is disposed above the level of the cleaning fluid and is adapted to be supplied with cleaning fluid from the cleaning fluid reservoir by means of a motor-driven pumping device. For this purpose, the receptacle is connected with the cleaning fluid reservoir via an overflow device and/or via at least one outlet opening.

### SUMMARY

In one aspect of the invention, a cleaning device for a shaving apparatus includes an upper portion with a cleaning receptacle for receiving the shaving head section of the shaving apparatus and an electric-motor-powered cleaning fluid impeller. The cleaning device includes support for the upper portion of the cleaning device upon a replaceable cartridge holding a supply of cleaning fluid.

The device may be equipped with a replaceable cartridge while being of compact and straightforward design. As the cartridge is not surrounded by the housing of the cleaning device, an elaborate mechanism for inserting and removing the cartridge is not necessary. Furthermore, the cleaning device requires a smaller depository area with the cartridge volume being maintained unchanged.

The upper portion and the cartridge may be releasably connected to one another by a coupling device. This ensures that the upper portion is securely held in place on top of the cartridge while enabling the cartridge to be replaced. In particular, the coupling device may be formed by cooperating coupling elements on the underside of the upper portion and on the top surface of the cartridge. Coupling elements arranged in this manner are not visible from outside when the upper portion and the cartridge are in coupled condition and, accordingly, do not adversely affect the visual impression. For example, the coupling device may be constructed as a screwed joint affording ease of manufacture and use. It is also possible for the coupling device to be constructed as a detent mechanism enabling the cartridge to be replaced very quickly. To facilitate handling during cartridge replacement, the upper portion may be equipped with feet for supporting the upper portion on a suitable surface when the cartridge has been removed.

Furthermore, the upper portion may include an activating device for setting the shaving apparatus in operation, at least temporarily. A particularly good cleaning result may be accomplished. The activating device may be constructed as at least one electrical contact. In one implementation, the outer contour of the cartridge may be shaped to conform to the outer contour of the upper portion in the area of transition to the upper portion in order to provide for a good connection between the upper portion and the cartridge as well as an aesthetically pleasing appearance.

In another aspect of the invention, a replaceable cartridge for holding a supply of cleaning fluid for an electric cleaning device for cleaning a shaving apparatus is provided. The cartridge is constructed as a supporting base of the cleaning device.

The cartridge is typically provided with at least one coupling element for creating a releasable mechanical connection with an upper portion of the cleaning device. The coupling element may be formed on the cartridge top surface which is provided for coupling to the upper portion of the cleaning device. This permits a simple construction of the coupling element which can be implemented with little effort. In one implementation, the coupling element may be constructed as a centrally located thread. In another implementation, the coupling element may be constructed as part of a detent mechanism.

Furthermore, provision may be made on the cartridge for a viewing window for reading the level of the cleaning fluid. Therefore, the level can be checked with very little effort. Because the cartridge is typically not concealed by housing parts of the cleaning device, reading of the fluid level through the viewing window is not subject to parallax errors, nor is an illuminating device necessary for visualization of the level of cleaning fluid.

The cartridge may taper towards its top surface to ensure a highly stable position. The cartridge may have a circular cross-section, hence the cartridge can be screw threaded onto the upper portion of the cleaning device.

Another aspect of the invention features a system that includes a shaving apparatus and the cleaning device as described above. The shaving apparatus possesses a cleaning function that is activatable by the cleaning device in the sense of setting the shaving apparatus in operation temporarily during a cleaning cycle. The shaving apparatus may be equipped with a cleaning program optimally suited for its configuration and of eliminating the expenditure incurred by providing the cleaning device with the cleaning program.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a cleaning device with a shaving apparatus inserted.

FIG. 2 is a perspective view of the cleaning device of FIG. 1, absent the shaving apparatus.

FIG. 3 is a perspective view of the cleaning device of FIG. 1 with the cartridge removed.

FIG. 4 is a perspective view of another cleaning device with the cartridge removed.

Like reference symbols in the various drawings indicate like elements.

### DETAILED DESCRIPTION

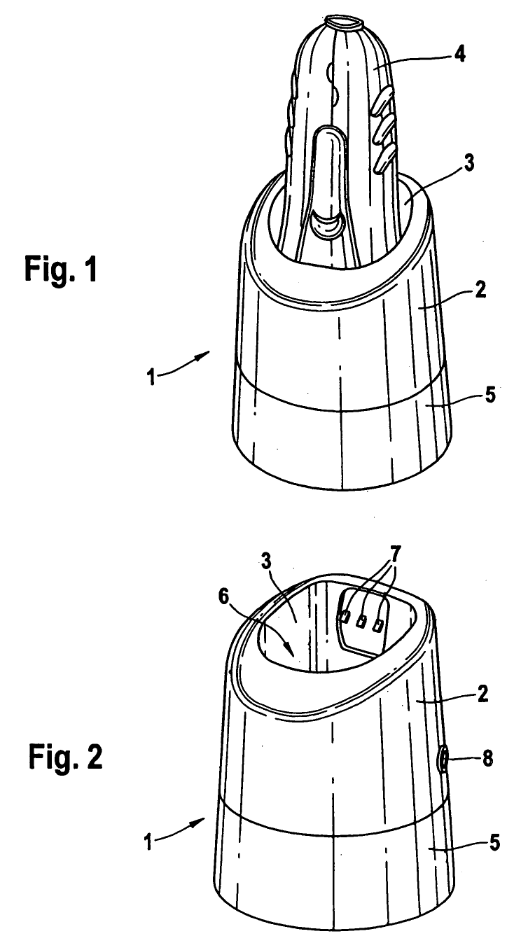

Referring to FIG. 1, a cleaning device 1 includes an upper portion 2 with a receiving opening 3. The shaving head section of an electric shaving apparatus 4 is inserted into the receiving opening 3. The upper portion 2 accommodates the components necessary for operation of the cleaning device 1. Components which are not visible from outside (and therefore not shown in FIG. 1) include, for example, a fluid impeller for conveying a cleaning fluid, an electric motor for driving the fluid impeller, etc. A replaceable cartridge 5 is arranged underneath the upper portion 2. The replaceable cartridge 5 is constructed as a base of the cleaning device 1 and carries the upper portion 2. In addition to functioning as a support for the cleaning device 1, the cartridge 5 serves to hold a supply of cleaning fluid. When the cleaning fluid is spent or heavily soiled, a fresh supply of cleaning fluid is made available by replacing the cartridge 5. As shown, the outer cylindrical surfaces of the upper portion 2 and the cartridge 5 merge smoothly together without any radial offset, so that, to the viewer's eye, the cartridge 5 does not appear as a foreign component but as an integral part of the cleaning device 1. The cleaning device 1 tapers from bottom to top to ensure a stable position. This applies to both the upper portion 2 and the cartridge 5. Both the upper portion 2 and the cartridge 5 are largely of circular cross-section.

Referring to FIG. 2, the cleaning device 1 FIG. 1 is shown without the shaving apparatus 4 so that a cleaning receptacle 6, accessible through the receiving opening 3, is exposed. The head section of shaving apparatus 4 is inserted into the cleaning receptacle 6 during the cleaning cycle. The cleaning receptacle 6 may be filled with cleaning fluid conveyed by the fluid impeller from the cartridge 5 into the cleaning receptacle 6. Disposed in the area of the cleaning receptacle 6 are electrical contacts 7. The electrical contacts 7 engage corresponding contacts on the shaving apparatus 4, when the shaving apparatus is inserted in the cleaning receptacle 6. An electrical connector 8 is provided on the outside of the upper portion 2. An operating voltage can be supplied to the upper portion 2 through the electrical connector 8. Furthermore, the upper portion 2 may also include a switch (not shown in the drawings) for starting the cleaning cycle if it is not desired to have the cleaning cycle started automatically on contact of the electrical contacts 7 with the shaving apparatus 4.

During the cleaning cycle, the shaving head of the shaving apparatus 4 can be set in operation through the electrical contacts 7, so that a relative motion of the components of the shaving head and the cleaning fluid is produced, thereby enabling a thorough cleaning operation to be accomplished. Depending on the configuration of the cleaning device 1, the electrical contacts 7 are operable to start, for example, a cleaning routine held in memory in the shaving apparatus 4. Under the cleaning routine, the shaving head is set in operation automatically for one or more set periods. In the cleaning routine, provision is made for a soaking period without shaving head operation between the operating periods. Storing the cleaning routine in the shaving apparatus 4 enables the cleaning device 1 to be of relatively simple construction. However, the possibility also exists for the cleaning routine to be stored in the cleaning device 1 and to control the shaving apparatus 4 in accordance with the cleaning routine via the electrical contacts 7. Furthermore, the electrical contacts 7 may be used for supplying a charging current to a shaving apparatus 4 powered by a rechargeable battery.

Depending on the construction of the cleaning device 1, a flow of liquid produced by the fluid impeller is circulated around the shaving head of the shaving apparatus 4 during the cleaning cycle, or the shaving head is immersed in the cleaning fluid contained in the cleaning receptacle 6 rather statically. On completion of the cleaning cycle, the cleaning fluid, including the debris dislodged from the shaving head, returns to the cartridge 5 where the debris settles in the course of time. A filter may be provided to prevent the debris from being fed back to the cleaning receptacle 6 together with the cleaning fluid.

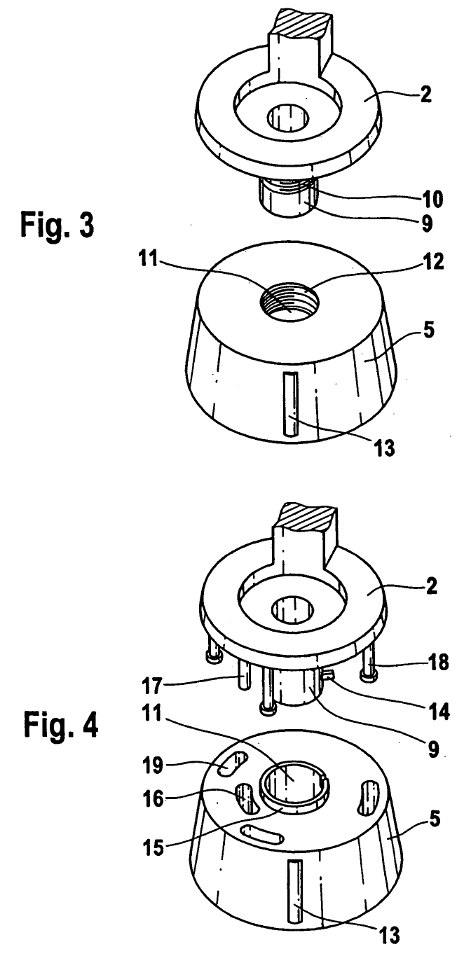

FIG. 3 shows the cleaning device 1 with the cartridge 5 removed. The upper portion 2 has, on its underside, a centrally located tubular extension 9 provided with an external thread 10 at least in a partial area adjacent to the underside. The cartridge 5 has, on its upper side, a likewise centrally located circular opening 11 with an internal thread 12 on its periphery. The external thread 10 and the internal thread 12 are in mated relationship to each other so that the upper portion 2 can be screwed down on the cartridge 5, thereby enabling a releasable mechanical connection to be established between the upper portion 2 and the cartridge 5. To accomplish said mechanical connection, the tubular extension 9 of the upper portion 2 is introduced into the opening 11 of the cartridge 5 until the external thread 10 contacts the internal thread 12. Then, the upper portion 2 and the cartridge 5 are rotated against each other and thereby screwed together. Owing to the central location of both the external thread 10 and the internal thread 12, the underside of the upper portion 2 rests congruently against the top surface of the cartridge 5 when screwed together. In this condition, the tubular extension 9 reaches through the opening 11 into the cartridge 5 by an amount enabling the cleaning fluid to be discharged from the cartridge 5. In order to enable the fluid level of the cleaning fluid to be checked, the outer circumferential surface of the cartridge 5 has a viewing window 13 embedded in the outer circumferential surface of the cartridge 5. Through the viewing window 13, the fluid level of the cleaning fluid is readable. When the fluid level is insufficient, the cartridge 5 is unscrewed from the upper portion 2 and a new cartridge 5 is threaded onto the upper portion 2.

FIG. 4 shows another cleaning device 1 with the cartridge 5 removed. The cleaning device, as shown in FIG. 4, differs from the cleaning device, as shown FIG. 3, for example, in the construction of the coupling mechanism between the upper portion 2 and the cartridge 5. A bayonet-type connection is provided in lieu of a threaded connection. This includes, for example, a detent element 14 which is provided on the tubular extension 9 of the upper portion 2 for snap-lock engagement with a mating element 15 arranged in the area of the opening 11 of the cartridge 5. For snap-lock engagement of the detent element 14 with the mating element 15, the underside of the upper portion 2 and the top surface of the cartridge 5 are brought close together in a predetermined angular position and then rotated relative to each other through a defined angle of rotation. To facilitate the snapping engagement, the cartridge 5 has a guide opening 16 on its top surface for guided entry of a prong 17 arranged on the underside of the upper portion 2. The guide opening 16 is constructed as an elongated hole curved in the manner of a circular arc. In a first end position of the prong 17 in the guide opening 16, the detent element 14 is snapped into the mating element 15, causing the upper portion 2 and the cartridge 5 to be fixedly connected with each other. In a second end position, the mating element 15 releases the detent element 14 to enable the cartridge 5 to be detached from the upper portion 2.

For ease of replacement of the cartridge 5, the upper portion 2 in the example shown in FIG. 4 has three feet 18 arranged on the underside of the upper portion 2 and serving to support the upper portion 2 when removed from the cartridge 5. To prevent the feet 18 from interfering with the joining together of upper portion 2 and cartridge 5, the cartridge 5 has on its top surface three additional apertures 19 that are shaped similarly to the guide opening 16 and receive the feet 18.

A number of embodiments of the invention have been described. Nevertheless, it will be understood that various modifications may be made without departing from the spirit and scope of the invention. Accordingly, other embodiments are within the scope of the following claims.

What is claimed is:

1. An electric shaving apparatus cleaning device comprising:
an upper portion defining a cleaning receptacle configured to receive a shaving head section of a shaving apparatus;
an electric motor powered cleaning fluid impeller; and
a replaceable cartridge holding a supply of cleaning fluid, wherein the replaceable cartridge supports the upper portion of the cleaning device.

2. The shaving apparatus cleaning device according to claim 1, wherein the upper portion and the replaceable cartridge are releasably connected with one another by a coupling device.

3. The shaving apparatus cleaning device according to claim 2, wherein the coupling device is formed by cooperating coupling elements on an underside of the upper portion and on a top surface of the replaceable cartridge.

4. The shaving apparatus cleaning device according to claim 2, wherein the coupling device comprises a screwed joint.

5. The shaving apparatus cleaning device according to claim 2, wherein the coupling device comprises a detent mechanism.

6. The shaving apparatus cleaning device according to claim 1, wherein the upper portion has supporting feet configured to support the upper portion on a surface when the cartridge has been removed.

7. The shaving apparatus cleaning device according to claim 1, wherein the upper portion includes a shaving apparatus activating device that sets the shaving apparatus in operation at least temporarily.

8. The shaving apparatus cleaning device according to claim 7, wherein the shaving apparatus activating device comprises at least one electrical contact.

9. The shaving apparatus cleaning device according to claim 1, wherein an outer contour of the cartridge is shaped to conform to an adjacent outer contour of the upper portion.

10. A replaceable cleaning fluid cartridge for an electric shaving apparatus cleaning device, the cartridge comprising
a body defining an interior cavity containing shaving apparatus cleaning fluid, the cartridge defining an aperture for hydraulic communication with the cavity;
wherein the body has an outer surface configured to interface with an associated shaving apparatus cleaning device so as to bear the weight of the cleaning device.

11. The cleaning fluid cartridge according to claim 10, comprising at least one coupling element configured to create a releasable mechanical connection with an upper portion of the associated shaving apparatus cleaning device.

12. The cleaning fluid cartridge according to claim 11, wherein the coupling element is located on an upper surface of the cartridge and releasably connects to the upper portion of the associated shaving apparatus cleaning device.

13. The cleaning fluid cartridge according to claim 11, wherein the coupling element comprises a centrally located thread.

14. The cleaning fluid cartridge according to claim 11, wherein the coupling element comprises a part of a detent mechanism.

15. The cleaning fluid cartridge according to claim 10, further comprising a fluid level viewing window, configured such that a level of cleaning fluid in the cartridge is visible through the fluid level viewing window.

16. The cleaning fluid cartridge according to claim 10, wherein the cartridge tapers from a first outer dimension to a second outer dimension, the second outer dimension nearer a cartridge top surface than the first outer dimension and smaller than the first outer dimension.

17. The cleaning fluid cartridge according to claim 10, wherein the cartridge has a circular cross-section.

18. A cleaning fluid system comprising:
a shaving apparatus; and
an electric shaving apparatus cleaning device for said shaving apparatus, wherein the shaving apparatus cleaning device is constructed according to claim 1 and the shaving apparatus has a cleaning function that is activatable by the shaving apparatus cleaning device.

19. The cleaning fluid system of claim 18 wherein the cleaning function that is activatable by the shaving apparatus cleaning device is operable to temporarily set the shaving apparatus in operation during a cleaning cycle.
